(19) United States
(12) Patent Application Publication
(10) Pub. No.: US 2022/0037709 A1
(43) Pub. Date: Feb. 3, 2022

(54) BATTERY

(71) Applicant: McLaren Automotive Limited, Woking (GB)

(72) Inventors: Sunoj Cherian George, Woking (GB); James Douglas McLaggan, Woking (GB); Elie Talj, Woking (GB)

(21) Appl. No.: 17/277,249

(22) PCT Filed: Sep. 17, 2019
(86) PCT No.: PCT/GB2019/052610

§ 371 Date: Mar. 17, 2021

(30) Foreign Application Priority Data
Sep. 18, 2018 (GB) 1815188.6

(51) Int. Cl. H01M 10/613; H01M 50/271; H01M 50/507; H01M 50/289; H01M 10/6556; H01M 50/213; H01M 10/625; H01M 10/6567; H01M 50/249; H01M 10/643

(52) U.S. Cl. CPC H01M 10/613; H01M 50/271; H01M 50/507; H01M 50/289; H01M 10/6556; H01M 2220/20; H01M 10/625; H01M 10/6567; H01M 50/249; H01M 10/643; H01M 50/213

(57) ABSTRACT

A battery comprising a battery housing, a lid for closing the housing and defining therein a chamber; and a plurality of battery modules within the chamber, each module having a plurality of battery cells, and a longitudinal cell tray for supporting the plurality of cells, wherein the cells of the battery modules are open to the chamber.

This invention relates to a battery and, in particular, a battery which contains a plurality of individual battery modules.

Electric powered or hybrid vehicles are well known and are becoming more and more prevalent as the desire to reduce carbon emissions increases. In such vehicles, the power that can be provided by, and the weight of, the battery is vital in determining the performance of the vehicle. The power to weight ratio of the battery is therefore something that vehicle designers are trying to optimise. This can clearly be done either by increasing the power generated for a given weight or by reducing the weight for a given power output, or most likely a combination of the two.

The batteries in electric or hybrid vehicles are typically made up of a plurality of individual battery cells connected together in such a way to allow large amounts of power to be provided to drive the wheels or power other systems in the vehicle. These cells are typically provided in the form of one or more battery modules which can be electrically connected.

Battery cells have optimum operating conditions and, in particular, operating temperatures. If the battery cells are outside of these optimum conditions, then the performance of the cells can deteriorate and the power the cells can provide is reduced. Alternatively or additionally, overheating can affect the operating life and/or general reliability of the battery cells, which is also undesirable.

It is known to provide individual battery modules within a battery compartment, each module having a cell support structure within a module housing, the cell support structure supporting a plurality of battery cells. Coolant is provided within the module housing to maintain the battery cells at the optimum temperature. It is possible to have multiple such modules with the battery compartment and it is known to have coolant within that battery compartment for cooling the battery modules.

According to the present invention, there is provided a battery comprising a battery housing; a lid for closing the housing and defining therein a chamber; and a plurality of battery modules within the chamber, each module having a plurality of battery cells, and a longitudinal cell tray for supporting the plurality of cells, wherein the cells of the battery modules are open to the chamber.

The present invention also provides a battery module for use in a battery, the module comprising a plurality of battery cells; a longitudinal cell tray for supporting the plurality of cells; and at least one baffle on a first side of the cell tray for shielding the cells from the cells in an adjacent battery module.

Such a battery is advantageous as it minimises material usage due to the cells of all the modules being open to the chamber defined by the battery housing and lid. By “open to the chamber”, we mean that the cells of the modules are not surrounded by any structure other than the cell tray which holds the cells, and the battery housing and lid—there is therefore a continuous space extending around the exposed portions of the cells, and from end to end, top to bottom, and side to side within the battery. This means that no individual module housing is required, therefore reducing the weight of the battery module. The provision of a baffle in a battery module, and therefore between adjacent similar modules acts to reduce or avoid the risk of electrical arcing or shorting between the cells of adjacent modules, thereby allowing adjacent modules to be located close to one another. This minimises material usage and therefore the weight of the battery for a given power output and also reduces the overall battery size, whilst ensuring that each battery module is not affected by an adjacent module.

A busbar may be provided on each end of the cells. Adjacent busbars of adjacent battery modules may be separated by a baffle.

The battery preferably has an inlet opening and an outlet opening, the respective opening allowing coolant to flow into or out of the housing.

There may be multiple inlets and/or outlets and, in particular, there may be an inlet opening and an outlet opening associated with each module.

Each module may have its own inlet and outlet openings.

The openings may be configured such that coolant flow for adjacent modules is complementary. In particular, for adjacent modules, the inlet opening for a first module may be on the opposite side of the module to the inlet opening for a second adjacent module.

An inlet opening and/or an outlet opening may be associated with more than one module.

Module to module busbar connectors may be provided within the housing, the connectors being positioned such that, in use, they are contacted by the coolant.

### BRIEF DESCRIPTION OF THE DRAWINGS

FIG. 1 shows a battery.

FIG. 2 shows a battery module from the front.

FIG. 3 shows a battery module from the back.

FIG. 4 shows a cell tray.

FIG. 5 shows a cell tray holding cells.

FIG. 6 shows the busbars and flexible printed circuit of a battery module.

FIG. 7 shows the cells, busbars and module terminals of a battery module.

FIG. 8 shows a battery housing.

FIG. 9 shows a schematic arrangement of battery modules without a module housing.

FIG. 10 shows a further schematic arrangement of battery modules without a module housing.

FIG. 11 shows a battery from the back.

### DETAILED DESCRIPTION OF THE DRAWINGS

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### Battery Overview

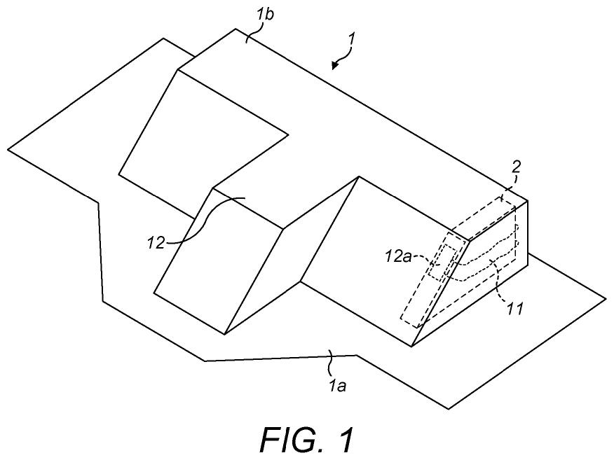

FIG. 1 shows a battery 1 which may comprise a number of identical battery modules 2. The battery modules may be arranged in a row. The battery may comprise any number of battery modules 2. In the example depicted in FIG. 1, one battery module 2 is shown for clarity, but in a preferred example there may be thirteen modules.

The battery may be installed in a vehicle. FIG. 1 shows the battery 1 fixed to a battery floor 1a. The battery floor 1a may be structurally integral to the vehicle in which the battery is installed. For example, the battery floor may be a load bearing component of a vehicle chassis. The battery floor 1a may be configured to be removably fitted to the vehicle so that the battery 1 can be removed from the vehicle. For example, for maintenance or replacement of the battery 1.

The battery 1 may further comprise a battery control unit 12 which protrudes from the row of battery modules. The battery control unit 12 may be electrically connected to one or more module control units 12a. Each battery module 2 may comprise an attached module control unit 12a. The battery control unit 12 may control each battery module control unit 12a. Each battery module control unit 12a may control the activity of the respective attached battery module. Each battery module control unit 12a may receive information concerning the operation of the respective attached battery module. The battery module control units 12a may process that information and feed that information to battery control unit 12.

The battery modules and battery control unit 12 may be enclosed by the battery floor 1a and a battery housing 1b.

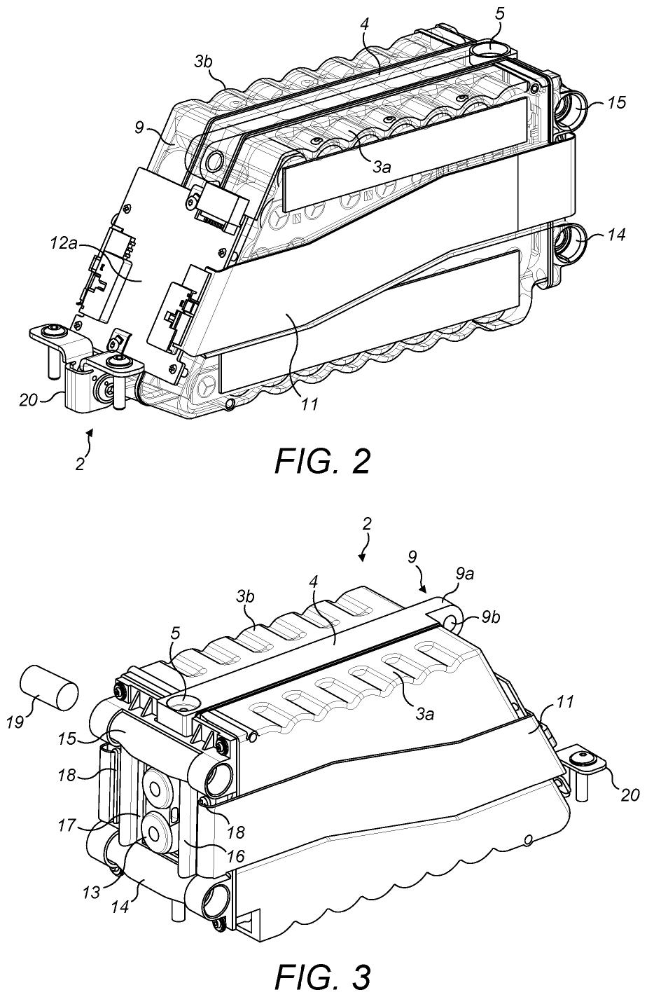

FIG. 2 shows a battery module 2 with a trapezoidal prism shape. The battery module depicted in FIG. 2 comprises a cell tray 4 and a two-part housing 3a, 3b. In FIG. 2, the battery module 2 and the cell tray 4 share a common longitudinal axis.

### Cell Tray

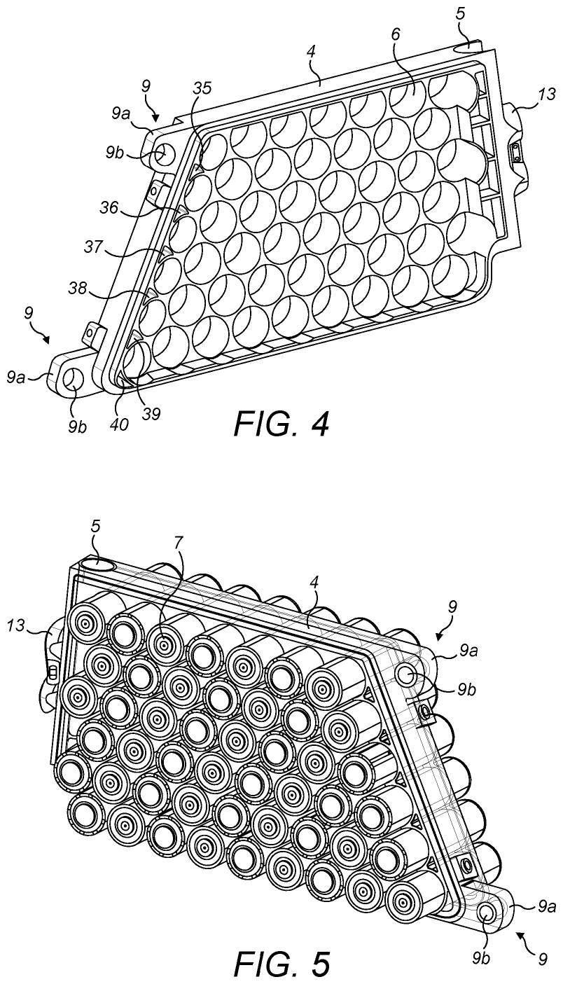

An exemplary cell tray 4 is shown in FIG. 4. The cell tray depicted in FIG. 4 comprises cell holes 6 for holding cells (not shown). Each cell hole 6 may extend through the cell tray in a direction perpendicular to the longitudinal axis of the cell tray. The cell tray may be formed of electrically insulating material.

The cell tray may further comprise a fixing hole 5 configured to receive a fixing element (not shown) for securing the cell tray 4, and hence the battery module 2, to the battery floor (not shown).

FIG. 4 shows the cell tray 4 comprising two fixings 9, each fixing comprising a tab 9a, the tab forming a connection hole 9b. Both fixings are generally positioned in the same plane as the cell tray. Each connection hole 9b may extend through its respective tab 9a in a direction parallel to the direction in which the cell holes 6 extend through the cell tray 4. The cell tray may comprise more than two fixings. The cell tray may comprise a single fixing. Fixings on multiple battery modules may receive one or more common elements so that the battery modules can be secured to one another.

FIG. 5 shows a number of cells 7 being held in the cell holes 6 of the cell tray 4. The cell tray may be configured to hold any number of cells. In the example depicted in FIG. 5 there are forty-eight cells held in respective cell holes 6. Each cell hole may hold one cell.

Resin may be poured into a recessed side of the cell tray. The resin may harden around cells placed in the cell tray so as to secure the cells in the cell tray. Alternatively, each cell 7 may be held in a cell hole 6 by an interference fit between the cell tray 4 surrounding the cell hole and the cell inserted into the respective cell hole.

Each cell hole may extend through the cell tray in a direction perpendicular to the longitudinal axis of the cell tray. In the example cell tray depicted in FIGS. 4 and 5, each cell hole is cylindrical so as to accommodate cylindrical cells. In other examples, each cell hole may be prismatic so as to accommodate prismatic cells.

The length of each cell may be greater than the length of each cell hole. Each cell 7 comprises a positive terminal and negative terminal. When a cell 7 is inserted into a cell hole 6, a length of the cell 7 comprising the positive terminal of the cell may protrude from the cell hole on one side of the cell tray 4 whilst a length of the cell 7 comprising the negative terminal protrudes from the cell hole on the other side of the cell tray. The portion of the cell 7 comprising the positive terminal and the portion of the cell 7 comprising the negative terminal may protrude from opposite sides of the cell tray. The protruding length of the portion of the cell comprising the cell's positive terminal and the protruding length of the portion of the cell comprising the cell's negative terminal may be equal.

The battery module 2 shown in FIG. 2 comprises a two-part module housing 3a, 3b. The housing 3a, 3b may form two enclosed regions which contain the cells 7 held in the cell tray 4. In FIG. 2, one part of the module housing 3a encloses the portions of cells protruding on one side of the cell tray. The second part of the module housing 3b encloses the portions of the cells protruding on the opposite side of the cell tray. In FIGS. 2 and 3, the exterior faces of the battery module 2 comprise faces of the cell tray 4 and the housing 3a, 3b. Alternatively, the housing 3a, 3b may enclose the entirety of the cell tray. In this case, the exterior faces of the battery module would comprise faces of the housing 3a, 3b.

### Cell to Cell Busbars and Flexible Printed Circuit Board

FIG. 7 shows busbars 10 contacting the terminals of multiple cells to form electrical connections between the multiple cells 7. The busbars 10 are formed of electrically conductive material. The busbars 10 may be formed of metal, for example copper or aluminium.

As above, the cell tray 4 (not shown in FIG. 7) fixedly holds cells 7, each cell having a positive terminal and a negative terminal. The busbars 10 may link the cell terminals of any number of cells.

Cells 7 may be arranged in the cell tray 4 so that positive and negative cell terminals protrude from opposite sides of the cell tray. In this way, a current flow path may be created through cells and busbars. For example, the current flow path may “snake” through the battery module. The current flow path may repeatedly intersect the cell tray. The current flow path may repeatedly intersect the longitudinal axis of the battery module. At least some of the cells may be connected in parallel by the busbars 10, meaning that the current flow path passes through multiple cells as the current flow path intersects the cell tray.

Module terminals 13 are shown in FIG. 7. The module terminals 13 are positioned on the back of the battery module and may be integral to the cell tray 4 (not shown in FIG. 7). Module terminals 13 of neighbouring battery modules may be electrically connected, for example, by module to module busbars. The module terminals 13 allow a supply of current to and/or from the cells 7 of the battery module 2.

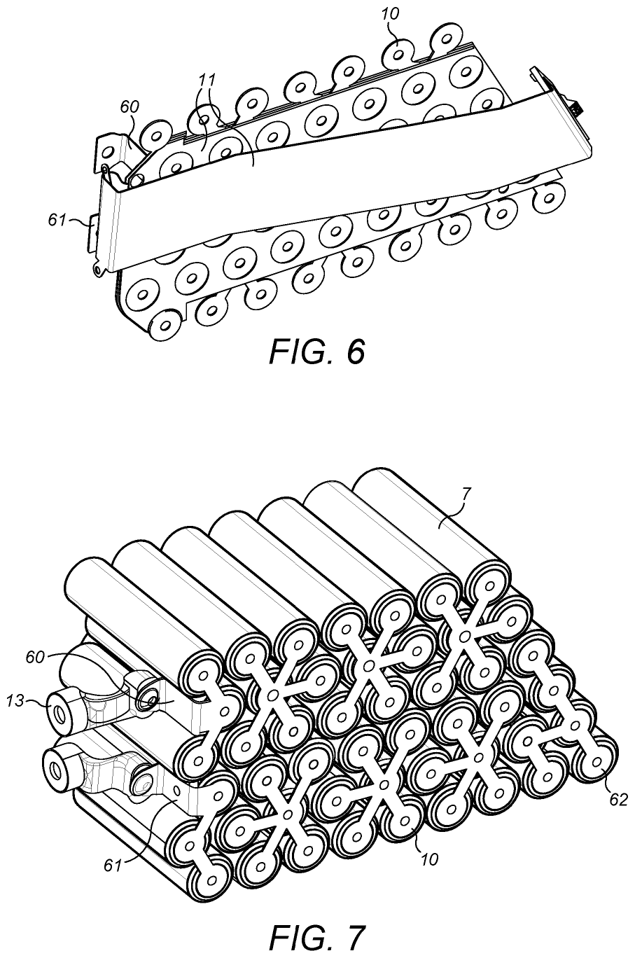

The busbars 10 may be integrated with a flexible printed circuit board (not shown in FIG. 7). FIG. 6 shows the flexible printed circuit board 11 of a battery module. A portion of the flexible printed circuit board 11 is located in the region enclosed by the module housing and another portion of the flexible printed circuit board 11 is wrapped around the exterior faces of both parts of the two-part module housing 3a, 3b, also shown in FIGS. 2 and 3.

The busbars 10 shown in FIGS. 6 and 7 may be integrated with the flexible printed circuit board 11. The busbars 10 may be configured to conduct a high level of current between the cells of the module and the module terminals 13.

The flexible printed circuit board 11 shown in FIG. 6 may further comprise sense wires. The sense wires may be configured to conduct a low current signal. The sense wires in the flexible printed circuit board may be attached to voltage sensors. Each voltage sensor may be capable of determining the voltage at a point on the busbar.

Each voltage sensor may be capable of determining the voltage being drawn from a cell. Each voltage sensor may be capable of inferring the voltage being drawn from a cell from a measurement taken of the voltage being drawn from a busbar 10. Each sense wire in the flexible printed circuit board may be capable of communicating voltage measurements from a voltage sensor to a module control unit 12a, shown in FIG. 1. The module control unit 12a may be capable of adapting the activity of the battery module in response to the voltage measurements provided by the sense wire. Each sense wire may be capable of communicating voltage measurements to the battery control unit. The module control unit 12a may be capable of communicating voltage measurements to the battery control unit. The battery control unit 12, also shown in FIG. 1, may be capable of adapting the activity of the battery module in response to the voltage measurements. The battery control unit 12 may be capable of adapting the activity of the battery in response to the voltage measurements.

The sense wires of the flexible printed circuit board 11 may be attached to one or more temperature sensors. A temperature sensor may be capable of determining the temperature of a part of the battery module. Each sense wire may be capable of communicating temperature measurements from a temperature sensor to the module control unit. The module control unit may be capable of adapting the activity of the battery module in response to the temperature measurements provided by the sense wire. Each sense wire may be capable of communicating temperature measurements to the battery control unit. The module control unit may be capable of communicating temperature measurements to the battery control unit. The battery control unit may be capable of adapting the activity of the battery module in response to the temperature measurements. The battery control unit may be capable of adapting the activity of the battery in response to the temperature measurements.

The sense wires may be attached to other types of sensors, for example current sensors, and/or fluid flow sensors.

FIGS. 6 and 7 also show terminal tabs 60, 61 which each of which connect either a positive or a negative end of the busbar to the respective positive or negative module terminal.

### Module Cooling

It is known to supply coolant to regulate the temperature of batteries. In typical batteries, the coolant is confined within coolant jackets or pipes. In such batteries, cells are cooled in areas of the cell which make contact with the jacket or pipe containing the coolant. This is a slow and inefficient cooling method.

In other typical batteries, coolant is not confined by coolant jackets or pipes, but makes direct contact only with the body/centre portion of each cell. In such batteries, the cell terminals are protected so that coolant does not make contact with the cell terminals. Such contact is avoided as it would typically lead to electrical shorting. This is also an inefficient method because the cell terminals, being electrically connected, are often the hottest parts of the cell and yet they are not directly cooled by the coolant.

By contrast, in the battery module described herein, coolant supplied to the battery module 2 makes direct contact with cell terminals, flexible printed circuit board 11, busbars 10, and cell body. The entirety of the cell and connected conducting parts are bathed in coolant. The coolant used is a dielectric oil. Dielectric oils have insulating properties. Cells drenched in dielectric oil are insulated from one another preventing short circuiting between cells. This is an efficient method of regulating cell temperature. Such efficient cooling enables the cells to operate at a higher power and for longer. This means that fewer and/or smaller cells are required to generate the same power as batteries utilising the previously mentioned cooling methods.

FIG. 3 shows a supply coolant conduit portion 14 and a drain coolant conduit portion 15. In the exemplary configuration shown in FIG. 3, the supply coolant conduit portion 14 is positioned in a lower position and the drain coolant conduit portion 15 is positioned in an upper position. Such a configuration reduces the risk of air locks occurring during filling. Alternatively, the supply coolant conduit portion may be positioned in an upper position and the drain coolant conduit portion may be positioned in a lower position.

Both coolant conduit portions may extend along the battery module in a direction orthogonal to the longitudinal axis of the battery module. Both coolant conduit portions may extend along the battery module in a direction orthogonal to the direction in which the fixing hole 5 extends through the cell tray 4. Both coolant conduit portions may extend along the battery module in a direction parallel to the direction in which the cell holes 6 extend through the cell tray 4.

As shown in FIG. 3, the supply coolant conduit portion 14 is linked to an inlet 16 in the battery module so that coolant may be supplied to a region enclosed by the housing of the battery module. The drain coolant conduit portion 15 is linked to an outlet 17 so that coolant may be drained from a region enclosed by the housing of the battery module. Inlet 16 and outlet 17 are openings formed in the module housing. The coolant may be supplied to one of the two regions enclosed by the housing and be drained from the other of the two regions enclosed by the housing, one region being on an opposite side of the longitudinal axis of the cell tray to the other region. The cell tray 4 may comprise through-holes 35 to 40 for allowing the passing of coolant from a respective one of the said regions to the other of the said regions. The through-holes may be located in the cell tray 4 at the end of the cell tray 4 remote from the inlet 16 and outlet 17. The through-holes may be shaped to promote even fluid flow over the cells.

As shown in FIG. 1, battery 1 contains a number of battery modules 2 arranged in a row. When battery modules 2 are positioned in a row, a coolant conduit portion 14 of one battery module aligns with a coolant conduit portion of a neighbouring battery module. The two coolant conduit portions may be connected to one another by a coupler 19, shown in FIG. 3. Couplers 19 form liquid tight connections between coolant conduit portions so that coolant may flow from portion to portion. When supply coolant conduit portions 14 of the battery modules in the row of battery modules are connected by couplers 19, they form a supply coolant conduit 14a which extends along the length of the row of battery modules. When drain coolant conduit portions 14 of the battery modules in the row of battery modules are connected by couplers 19, they form a drain coolant conduit 15a which extends along the length of the row of battery modules.

As shown in FIG. 1, the longitudinal axes of all the battery modules 2 in the row of battery modules of the battery 1, may be parallel to one another. Both coolant conduits 14a, 15a may extend along the row of battery modules in a direction orthogonal to the longitudinal axes of the battery modules in the row of battery modules. Both coolant conduits may extend along the row of battery modules in a direction orthogonal to the direction in which the fixing hole 5 extends through the cell tray 4 of each battery module. Both coolant conduits may extend along the row of battery modules in a direction parallel to the direction in which the cell holes 6 extend through the cell tray 4 of each battery module.

Inlet 16 and outlet 17 may be configured to allow coolant to enter and leave the battery module 2. Inlet 16 and outlet 17 may further act as passages through which the flexible printed circuit boards 11 pass between the interior and exterior of the battery module, as shown in FIG. 3. The inlet 16 and outlet 17 may be the only openings in the two-part housing 3a, 3b of the battery module 2. FIG. 3 shows sealant 18 around the inlet 16 and outlet 17. Sealant 18 ensures that coolant inside the battery module does not leak from the battery module into other parts of the battery.

The method of direct cell cooling described herein also has further advantages in the case that excessive pressure builds up inside a cell. Each cell may comprise a cell vent port. In the case that excessive pressure builds up inside the cell, the cell vent port may be activated, allowing fluids within the cell to escape the cell. The cell vent port may be configured to expel cell fluids in the event that pressure within the cell exceeds a threshold. Upon leaving the cell, the fluids are quenched by the surrounding coolant.

### Alternative Battery Configuration

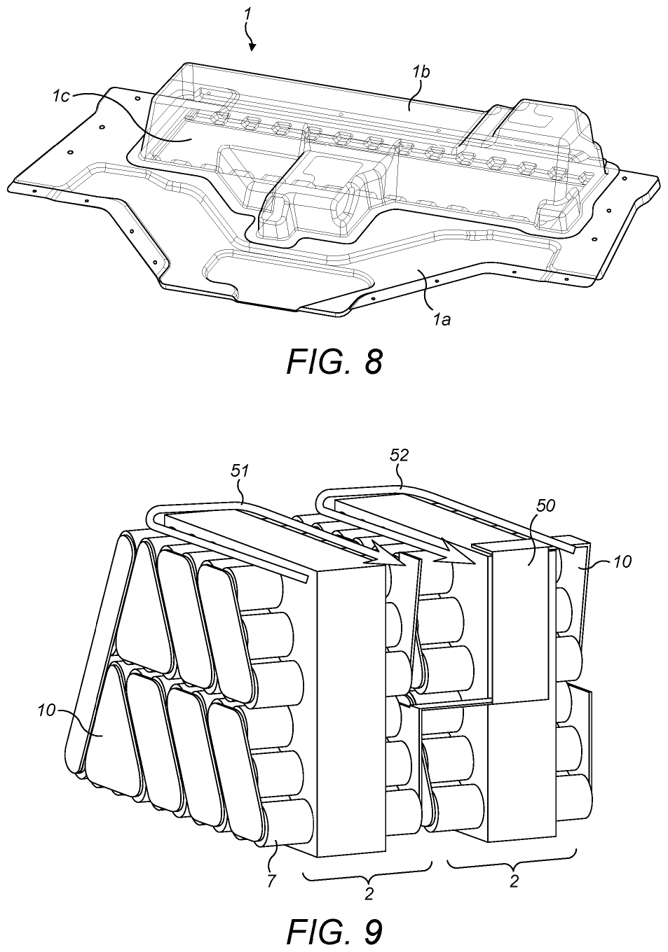

FIG. 8 is similar to FIG. 1, but shows simply the battery floor 1 a and the battery housing 1 b of the battery 1. These two items define therein a battery chamber 1c. Such a chamber can contain multiple battery modules as described above. Such modules are self-contained, in that each module has a discrete module housing in which the battery cells are located and through which coolant is caused to flow in order to cool the battery cells.

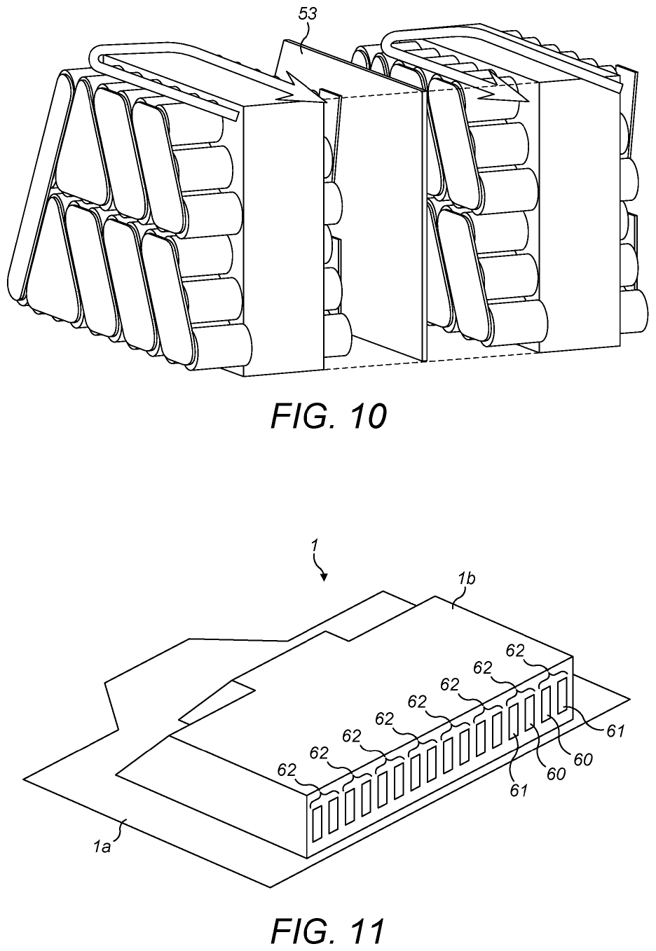

An alternative arrangement however can also be used in which each module within the battery is of the form shown in FIG. 9 or 10. In this arrangement, each battery module 2 exists without an individual module housing. The battery modules, by way of a fixing element being placed in the through hole 5 in the cell tray 4 shown in FIGS. 2 and 3, are fixed directly onto the battery floor 1a and enclosed in the battery chamber 1c by the battery housing 1b. Such a fixing element may pass solely through the cell tray into the battery floor 1a, or may additionally pass through the battery housing 1b. Multiple such modules can be provided within a single battery housing. The battery housing 1b is adapted relative to that of FIG. 1 to include appropriately sized and positioned openings through which coolant can flow into and out of the battery housing. In this way, the coolant can flow directly around each battery module without the additional weight of the battery module housings, the coolant being retained in the chamber 1c defined by the battery floor 1a and the battery housing 1b.

The same general coolant flow is preferably maintained around each “housing-less” module of FIGS. 9 and 10 when compared to the housed modules described above in relation to FIGS. 2 and 3. Thus, coolant passes down one side of each module, through the end of the cell tray, and back along the opposite side of the cell tray. This can be achieved by the correct placing of the inlet and outlet openings through the battery housing 1b. The preferred coolant flow arrangement is shown in FIGS. 9 and 10 by way of arrows 51 and 52 which illustrate the general flow direction of coolant in adjacent modules 2. The adjacent modules have coolant flows that are opposite to each other. By this, we mean that either both inlet or both outlet coolant flows from adjacent modules are adjacent each other, with the respective other flow on the opposite side of the respective cell tray. In FIGS. 9 and 10, the two outlet coolant flows are adjacent, and the two inlet coolant flows are on the opposite sides of the respective cell trays. This arrangement reduces the risk of oppositely directed flow streams colliding, and thus the flow arrangement of FIG. 9 or 10 maximises the cooling effect of the coolant flow. Alternative flow schemes could be used, for example where each module has an inlet flow on a left side of the cell tray and an outlet flow on the right side, but this would lead to inlet and outlet coolant flows colliding, reducing the cooling that can be achieved. Instead of or as well as flowing through passages 35 to 40 through the distal end of the cell tray 4, coolant flow may pass around the end of the cell tray or may pass over the top (in the figures) surface of the cell tray. The cell tray 4 may be spaced from the battery housing 1b in one or more locations, in which case coolant flow may pass around or over the cell tray. Alternatively, the cell tray may abut the battery housing to prevent flow around and/or the cell tray.

The flow arrangement of FIG. 9 or 10 can be achieved, as shown in FIG. 11, by having one or more outlet openings 60 through the battery housing 1b aligned with the desired outlet flow streams and one or more inlet openings 61 through the battery housing 1 b aligned with the desired inlet flow streams. This could be a single inlet or outlet opening shared by two modules or could be individual inlet and outlet openings for each module. FIG. 11 shows eight pairs 62 of inlet and outlet openings, each pair typically serving a single module within the battery 1. The inlet 61 and outlet 60 opening on adjacent pairs are on opposite sides of the module which they serve, such that two outlet openings 60 are adjacent, or two inlet openings 61 are adjacent.

Adjacent modules are preferably separated by a baffle 53, as shown in FIG. 10, to prevent shorting between the busbars of adjacent modules. Although shown in an exploded view, the baffle is typically sufficiently thin, such as less than 2 mm, preferably less than 1 mm, in order that the overall size of an array of modules does not increase as the baffle does not adversely affect the volume of coolant that can pass around the cells. The baffle 53 also further helps to prevent mixing of different coolant flow streams, even when the flow is in the same direction. The baffle may be a generally planar element as shown in the figures and preferably is sized such that there is no direct line of sight between the cells of adjacent modules.

Where multiple battery modules are utilised in a battery, it is necessary for the busbars of the modules to be electrically connected. When using the modules of FIGS. 2 and 3, an electrical connection is made between the busbars of adjacent modules, with this connection being outside of the module housing. These connections carry high levels of current and typically get hot. In order that they do not fail, such connections are relatively large and therefore heavy. With the arrangement of FIG. 9 or 10 however, the module to module busbar connectors 50 are located within the battery housing which itself is filled with the coolant. As such, the module to module busbar connectors 50 can be made much smaller, as they are not subject to such high temperatures, thereby further saving weight.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A battery comprising:
a battery housing;
a lid for closing the housing and defining therein a chamber; and
a plurality of battery modules within the chamber, each module having a plurality of battery cells, a longitudinal cell tray for supporting the plurality of cells and one or more busbars on each end of the cells,
wherein the cells of the battery modules are open to the chamber, and wherein adjacent busbars of adjacent battery modules are separated by a baffle.

2. A battery according to claim 1, further comprising an inlet opening and an outlet opening, the respective opening allowing coolant to flow into or out of the housing.

3. A battery according to claim 2, comprising an inlet opening and an outlet opening associated with each module.

4. A battery according to claim 3, wherein each module has its own inlet and outlet openings.

5. A battery according to claim 1, wherein the openings are configured such that coolant flow for adjacent modules is complementary.

6. A battery according to claim 2, wherein, for adjacent modules, the inlet opening for a first module is on the opposite side of the module to the inlet opening for a second adjacent module.

7. A battery according to claim 2, wherein an inlet opening and/or an outlet opening are associated with more than one module.

8. A battery according to claim 1, further comprising module to module busbar connectors within the housing, the connectors being positioned such that, in use, they are contacted by the coolant.

9. A battery module for use in a battery according to claim 1, the module comprising:
a plurality of battery cells;
a busbar on each end of the cells;
a longitudinal cell tray for supporting the plurality of cells; and
at least one baffle on a first side of the cell tray for shielding the busbar on an end of the cells from the cells in an adjacent battery module.

10. A battery according to claim 4, wherein an inlet opening and/or an outlet opening are associated with more than one module.

11. A battery according to claim 5, wherein an inlet opening and/or an outlet opening are associated with more than one module.

12. A battery according to claim 6, wherein an inlet opening and/or an outlet opening are associated with more than one module.

13. A battery according to claim 3, wherein, for adjacent modules, the inlet opening for a first module is on the opposite side of the module to the inlet opening for a second adjacent module.

14. A battery according to claim 4, wherein, for adjacent modules, the inlet opening for a first module is on the opposite side of the module to the inlet opening for a second adjacent module.

15. A battery according to claim 5, wherein, for adjacent modules, the inlet opening for a first module is on the opposite side of the module to the inlet opening for a second adjacent module.

16. A battery according to claim 2, wherein the openings are configured such that coolant flow for adjacent modules is complementary.

17. A battery according to claim 3, wherein the openings are configured such that coolant flow for adjacent modules is complementary.

18. A battery according to claim 4, wherein the openings are configured such that coolant flow for adjacent modules is complementary.
